(19) United States
(12) Patent Application Publication
(10) Pub. No.: US 2026/0008181 A1
(43) Pub. Date: Jan. 8, 2026

(54) SYSTEM AND METHOD FOR DYNAMICALLY GUIDED VEHICLE SERVICING

(71) Applicant: NeySEA LLC, Overland Park, KS (US)

(72) Inventor: John NEYLAND, JR., Overland Park, KS (US)

(21) Appl. No.: 19/257,194

(22) Filed: Jul. 1, 2025

Related U.S. Application Data
(60) Provisional application No. 63/667,686, filed on Jul. 3, 2024.
(60) Provisional application No. 63/696,013, filed on Sep. 18, 2024.

(51) Int. Cl. B25J 9/16; G06T 7/00; G06T 7/70; G06V 10/143

(52) U.S. Cl. CPC B25J 9/1666; B25J 9/1697; G06T 7/0004; G06T 7/70; G06V 10/143

(57) ABSTRACT

A system for dynamically guided vehicle servicing may include scanning a service area with at least one image capture device to generate a dirt score that identifies at least one serviceable portion of the vehicle. In addition, the system may include generating a path along which end of arm tooling (EOAT) travels to perform a servicing operation on the at least one serviceable portion of the vehicle. The system may include moving the EOAT along the path in accordance with the dirt score and the servicing operation. Moreover, the device may include executing a damage mitigation operation if an unwanted overlap between a fenceless cell field of view and a service area field of view is detected.

### BACKGROUND

### 1. Field

The present disclosure relates generally to dynamically guided vehicle servicing.

### 2. Description of the Related Art

Current automated guided vehicle servicing systems are designed to follow a methodical, step-by-step cleaning process, which often results in extended wait times for customers, among other disadvantages.

### SUMMARY

The following is a non-exhaustive listing of some aspects of the present techniques. These and other aspects are described in the following disclosure.

The slow pace and logistical problems associated with existing robotic car washing systems present substantial challenges to both operators and consumers. As described above, current automated systems are designed to follow a methodical, step-by-step cleaning process, which often results in extended wait times for customers, for example. This inefficiency is particularly problematic during peak hours when demand surges, leading to long queues and significant delays. The slow pace undermines the convenience that automated carwashes are supposed to provide, reducing overall customer satisfaction and throughput for carwash operators.

Moreover, the rigid programming and mechanical limitations of these systems introduce several risks. Robotic carwashes rely on fixed algorithms and pre-set routines that do not always account for the unique contours and features of every vehicle. This inflexibility can lead to improper calibration or sensor malfunctions, which in turn cause uneven cleaning pressure. Such inconsistencies can damage a vehicle's paint or exterior features, resulting in micro-scratches, swirl marks, or even more severe damage to delicate finishes. High-pressure water jets, while effective at removing dirt, can strip away wax coatings and damage fragile parts such as antennas, mirrors, and trim pieces. Rotating brushes or cloth strips, another common component of these systems, can exacerbate the risk of abrasions and further degrade the vehicle's exterior.

Additionally, the potential for mechanical wear and tear is a significant concern. The use of these robotic systems leads to inevitable wear on moving parts, which requires frequent maintenance and replacement. This not only increases operational costs but also results in downtime, further diminishing the efficiency and reliability of the service.

Finally, various safety issues are frequently encountered with prior robotic car washing systems. These safety issues may include robot collisions with vehicles and/or people, process stops and starts at inconvenient or improper times, etc.

In light of these issues, there is a clear need for an improved robotic car washing system that addresses both the slow pace and other problems with current technologies. Enhancing the speed and efficiency of the cleaning process while minimizing the risk of damage to vehicles would significantly benefit both consumers and carwash operators. Novel solutions are described that overcome these and other limitations of existing systems, providing a faster, safer, and more reliable car washing experience.

In some implementations, a service area may be scanned with at least one image capture device to generate a dirt score that identifies at least one serviceable portion of the vehicle. An optimal path may be generated, along which an end of arm tooling (EOAT) travels to perform a servicing operation on the at least one serviceable portion of the vehicle. The EOAT moves along the optimal path in accordance with the dirt score and the servicing operation.

In some implementations, a service area is scanned with at least one thermal imaging device to determine if a person is within an area of interest. A mitigation operation is executed if the person is in an unwanted position within the area of interest.

In some implementations, a thermal state change within the service area is detected with the least one thermal imaging device; and a determination of whether the thermal state change indicates the existence of the person within the area of interest is made.

In some implementations, a position of a person relative to the EOAT and the vehicle is determined; and an issue response protocol is generated to avoid EOAT or other system component contact with the person within the area of interest.

In some implementations, the issue response protocol includes modifying an optimal path (of the EOAT or other system components) to avoid collision with the person. In some implementations, the issue response protocol includes removing unwanted chemicals from within an area surrounding the person. In some implementations, the issue response protocol includes generating a notification for emergency personnel that includes at least one of a time, a location, and a severity of an issue.

In some implementations, the at least one thermal imaging device includes longwave-infrared (LWIR) focal-plane arrays to enable passively cooled thermal-imaging operations. In some implementations, the at least one thermal imaging device is a plurality of thermal imaging devices distributed about the service area. The plurality of thermal imaging devices is optically coupled to the service area.

In some implementations, at least one reference datum point includes a plurality of reference datum points correlated to physical characteristics of the service area. In some implementations, the at least one reference datum point includes information captured by at least one thermal imaging device, the at least one image capture device, and at least one area monitor sensor.

In some implementations, the at least one thermal imaging device, the at least one image capture device, at least one area monitor sensor, and the EOAT communicate through a bidirectional stateless connection that is mediated by a multi-input multi-output (MIMO) sensor broker interface device.

In some implementations, the EOAT is interchangeable to enable the execution of a series of different servicing operations.

In some implementations, the service area is scanned with the at least one image capture device to determine a current position of a vehicle. A dynamic path recognition operation is performed to update the optimal path based on the current position of the vehicle or other information. A machine learning based dynamic path recognition model utilizes input from the least one thermal imaging device, the at least one image capture device, and at least one area monitor sensor. The machine learning model dynamically tracks objects in the service area, to predict the path of the objects within the service area, to prevent collisions, and to generate dynamically updated optimal paths for the EOAT based on the predicted paths.

A preliminary representation of the vehicle may be generated based on a disposition of at least one relevant physical characteristic of the vehicle as identified by the at least one image capture device. An optimal path may be generated by comparing the preliminary representation to at least one reference datum point.

In some implementations, relevant physical characteristics include a front wheel position and a rear wheel position for the vehicle, and/or other characteristics. In some implementations, a preliminary representation includes a wheelbase of the vehicle. The wheelbase equals a distance between the front wheel position and the rear wheel position. In some implementations, a front and rear offset value (FROV) included in the preliminary representation is equal to the wheelbase divided by Pi. An overall vehicle length (OVL) included in the preliminary representation equals a sum of the wheelbase and twice the FROV. In some implementations, the wheelbase, the FROV, and the OVL are input into the dynamic path recognition model for generating a first field of view characterized by the vehicle relative to the at least one computer vision device, a second field of view characterized by the vehicle relative to the EOAT, and a third field of view characterized by the vehicle relative to the at least one area monitor sensor.

In some implementations, thermal images are received from at least one thermal imaging sensor included in the at least one computer vision device. The thermal images are converted to grayscale binary images; and an exterior surface of the vehicle is mapped. Mapping the exterior surface uses the dynamic path recognition model to perform edge-detection-based computer vision analysis on the grayscale binary images. In some implementations, the EOAT includes a rotating spray nozzle connected to a feeder system, and the optimal path maneuvers the EOAT around the vehicle to wash a desired portion of an exterior surface of the vehicle. In some implementations, the EOAT includes a rotating brush mounted onto a boom arm, and the optimal path maneuvers the EOAT around the vehicle to brush a desired portion of an exterior surface of the vehicle. In some implementations, an encoder monitors the position of the boom arm.

In some implementations, the EOAT includes a blower device, and the optimal path maneuvers the EOAT around the vehicle to dry a desired portion of an exterior surface of the vehicle. In some implementations, the EOAT is mounted onto a robotic arm and moved through the service area by the robotic arm.

In some implementations, signals are received from a plurality of encoders indicating a position of the robotic arm; and instructions are sent to at least one motor associated with the robotic arm to generate relative movement between the EOAT and the vehicle such that the EOAT is oriented to perform the servicing operation without collision between the robotic arm, the EOAT, a person, or the vehicle. In some implementations, the robotic arm maneuvers the EOAT to ensure a current distance between the EOAT and the vehicle is greater than a minimum clearance distance.

In some implementations, at least one serviceable portion of the vehicle is identified based on the vehicle image data; and a cleanliness rating is generated based on the at least one serviceable portion and the vehicle image data. Implementations of the described techniques may include one or more hardware components that form a physical system, a method or process, or a tangible computer readable medium that stores instructions. The instructions are configured to cause a computer or other components of a system to perform one or more of the described operations.

### BRIEF DESCRIPTION OF THE DRAWINGS

FIG. 1A shows a block diagram of a dynamically guided vehicle servicing system, consistent with various implementations.

FIG. 1B shows a block diagram of an unwanted overlap between an operator and a robot's optimal path, consistent with various implementations.

FIG. 1C shows a block diagram of the operator entering an area of interest, consistent with various implementations.

FIG. 2 is a block diagram of the nested control loop structure of the system of FIG. 1A, consistent with various implementations.

FIG. 3 shows a flowchart of a method for dynamically guided vehicle servicing, consistent with various implementations.

FIG. 4 illustrates a preliminary representation of the vehicle, consistent with various implementations.

FIG. 5 shows an implementation where the system may employ at least one low-level loop to control the robot's actuators, consistent with various implementations.

### DETAILED DESCRIPTION

In the following description, for the purposes of explanation, numerous specific details are set forth in order to provide a thorough understanding of the different implementations. It will be appreciated, however, by those having skill in the art, that the implementations may be practiced without these specific details or with an equivalent arrangement. In other cases, well-known structures and devices are shown in block diagram form to avoid unnecessarily obscuring the various components of the described systems and methods.

The disclosed concept relates to system(s) and method(s) that utilize a constellation of sensors and computer vision devices to create a control framework for robotic vehicle servicing operations (e.g., washing a vehicle, applying paint to a vehicle, removing or repairing vehicle components). In some implementations, the control framework may enable the implementation of a fenceless cell or work cell for industrial robotic applications (e.g., spraying, brushing, wiping, scraping, bending, welding, cutting, grasping, and repositioning) involving vehicles, objects, and/or workpieces. A robot and a collection of machines or peripherals is referred to as a work cell, or cell. A typical cell might include a parts feeder, a molding machine, a robot, or other components. The various machines are ‘integrated’ and controlled by a single computer or programmable logic controller (PLC). How the robot interacts with other machines in the cell is programmed, both with regard to their positions in the cell and synchronizing with them.

Implementations of the fenceless cell employ a dedicated sensor array (e.g., three-dimensional radar, thermal imaging, force sensors, proximity sensors, or other sensors) to enable an industrial robot to operate at full speed without the need of a physical barrier fencing in the work cell. For example, the fenceless cell may determine when a person such as an operator enters an area of interest within a service area and generate an alert that causes the control framework to automatically implement a system shutdown operation that suspends the robot in the current position. As another example, a force sensor coupled to a robot may detect force associated with a collision (with a vehicle, an operator, etc.,) causes the control framework to automatically implement a system shutdown operation that suspends the robot in the current position (i.e., the robot is stopped). Alternatively, the system may dynamically modify the path of the robot to account for changes in the operator's position within the service area.

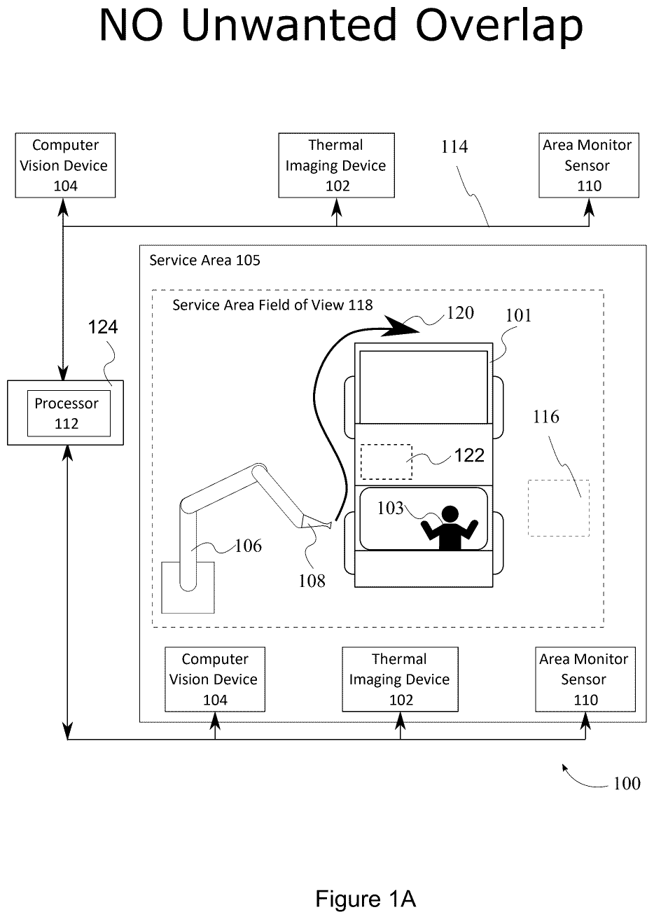

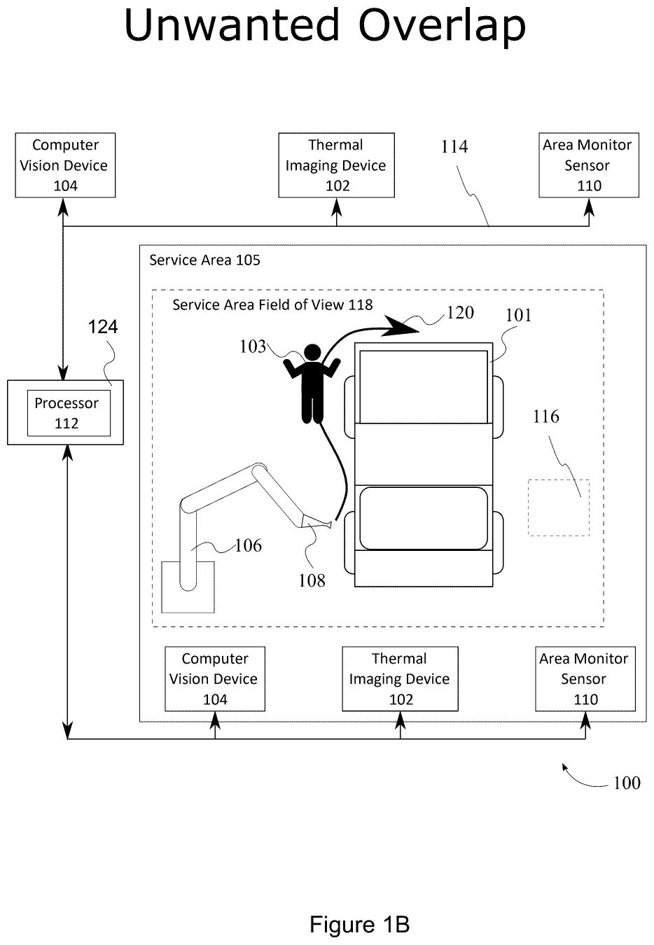

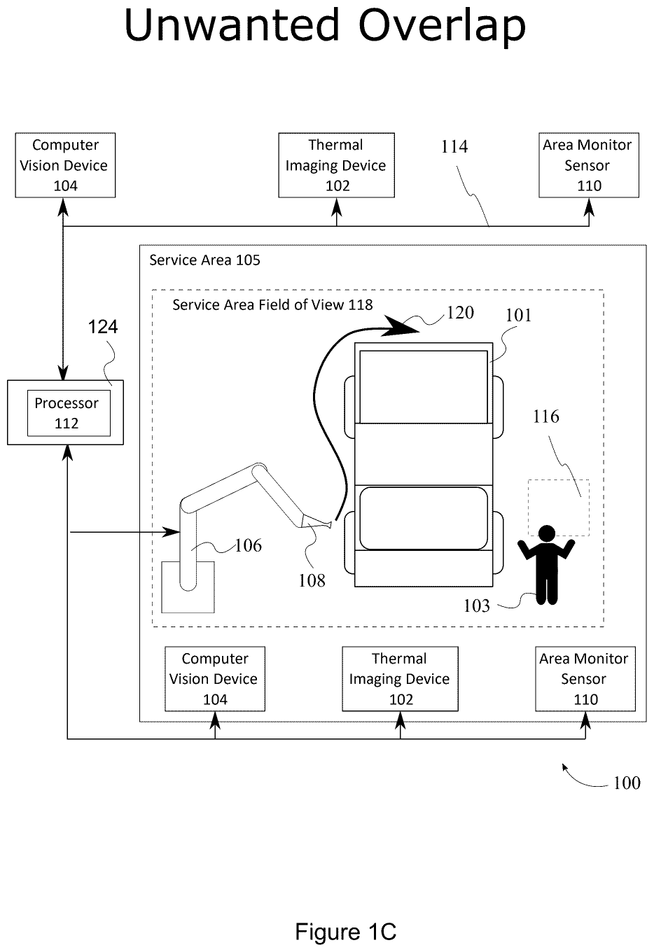

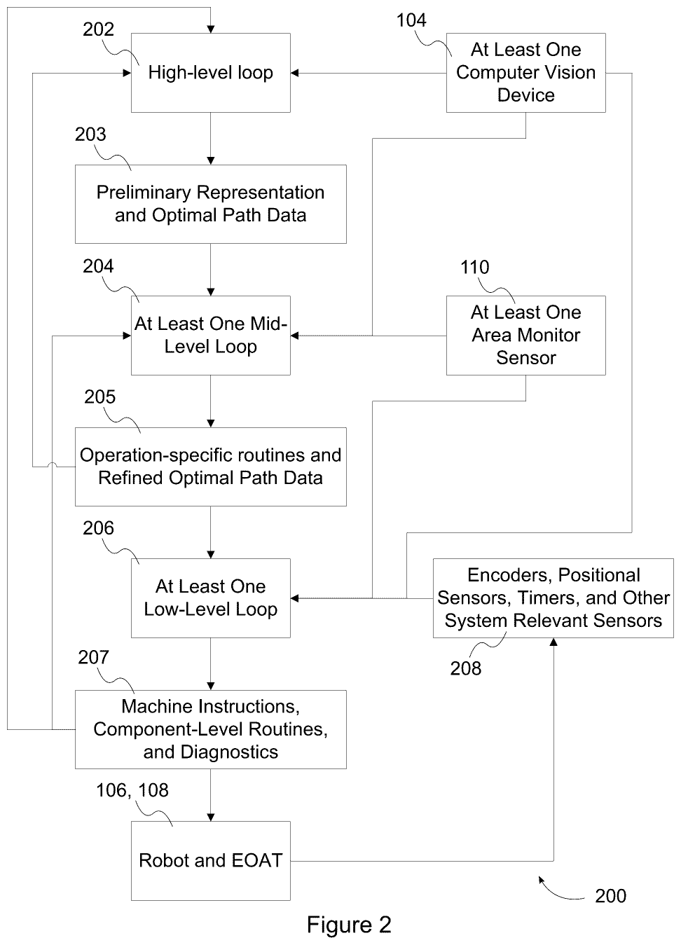

FIG. 1A shows an implementation of a system 100 comprising at least one thermal imaging device 102, at least one image capturing device (e.g. a camera, a video camera, a computer vision device, or other device 104), at least one a robot 106, and at least one area monitor sensor 110 (e.g., proximity sensors, LIDAR, safety light curtains, magnetometers, gyroscopes, force sensors, depth sensors, accelerometers, rotary encoders, linear encoders, optical encoders, and chemical sensors). The at least one thermal imaging device 102 may include and/or employ longwave-infrared (LWIR) focal-plane arrays to enable passively cooled thermal-imaging operations. The at least one computer vision device 104 may be a camera or other optical sensing system designed to enable at least one processor 112 (FIG. 2) to identify relevant characteristics of objects within a service area 105. The at least one area monitor sensor 110 may include a three dimensional stereoscopic depth imaging sensor configured for automatically generating a three dimensional depth/range map of a vehicle's pose and scene background, for example. Such a sensor may use a rolling shutter and output frame by frame arrays of three dimensional stereoscopic wide format camera point data, including cloud data, ASCI depth and position attributes of a still or moving vehicle (e.g., from a distance of up to about 20 meters).

Robot 106 may comprise an industrial robot, a cobot, a robotic arm, and/or other robots. An industrial robot is a programmable, mechanical device designed to perform a variety of tasks in manufacturing and production environments. These robots 106 are used here for tasks such as inspection, cleaning, etc.. As described above, they may be equipped with sensors and are capable of operating autonomously or under human control. A robotic arm is a type of mechanical arm with joints that can be controlled and programmed to perform specific tasks, mimicking the movement and functionality of a human arm, for example. It is a component in many industrial robots and can be used for a wide range of applications.

Cobots are similar to industrial robots, however they are configured to work closer to and with humans for the automation of certain tasks—hence the term Cobot or collaborative robot. Cobots may be relatively less expensive (e.g., up to about 15% less), less capable (but advantageous for certain specific applications), and/or generally safer compared to industrial robots and/or robotic arms, for example, as they may be configured stop if an operator gets into the path of a cobot (e.g., based on output from a force sensor mounted on a cobot). Cobots can move nearly as fast as there industrial robot counterparts but are configured to be speed reduced for safer operation (e.g., limited to run at about 1000-2000 mm per second). This speed reduction can be advantageous for cleaning vehicle panels, for example. Cobot speed may be configured to vary based on routine (e.g., traveling from a start position to a cleaning position relatively quickly, and then slowing to actually perform a cleaning operation). Cobots may be used alongside the industrial robots and/or robotic arms, or they may be used instead of these components.

Industrial robots, cobots, and/or robotic arms may include joints and links, actuators, sensors, controllers, and/or other components. For example, each robot 106 may include a processor 112 that can function semi-autonomously. Alternatively, the system 100 may be controlled by a remote server or processor 112. In some implementations, one or more thermal imaging devices 102, image capturing devices 104, area monitoring sensors 110 (e.g., a force sensor, a depth sensor, etc.), and/or other components may be coupled and/or otherwise mounted to a robot 106.

In some implementations, the at least one thermal imaging device 102, the at least one computer vision device 104, and the at least one area monitor sensor 110 are disposed such that the service area 105 is positioned within a field of view 118 thereof. The service area field of view 118 may refer to any area within the detectable range of the at least one thermal imaging device 102, the at least one computer vision device 104, and the at least one area monitor sensor 110. Further, the processor 112 may reposition the service area field of view 118 by adjusting the operational states of the at least one thermal imaging device 102, the at least one computer vision device 104, and the at least one area monitor sensor 110. For example, the service area field of view 118 may be narrowed to a section of the service area 105 when only a single robot 106 is operational or enlarged to encompass the entire service area 105 when working on a large truck. Further, the service area field of view 118 may include a plurality of contiguous and non-contiguous partitions. In some implementations, a plurality of each of the at least one thermal imaging device 102, the at least one computer vision device 104, and the at least one area monitor sensor 110 may be distributed about (e.g., within and/or around) the service area 105. Additionally, the at least one thermal imaging device 102, the at least one computer vision device 104, and the at least one area monitor sensor 110 may be operatively (e.g., optically, thermally, audibly) coupled to the service area for assessing changes in the position of the vehicle and/or a person such as an operator 103. The system 100 then uses this gathered information to plot a path 120 (e.g., an optimal path, a dynamically modified path, a collision avoidance path, a service path) along which a cleaning tool 108 for the robot 106 must move to perform the servicing operation. In some implementations, the cleaning tool 108 is end of the arm tooling (EOAT) 108 (e.g., brushes, spray nozzles, sponges, and grippers) for the robot 106. In FIG. 1A there is no unwanted overlap between the operator 103 and the area of interest 116, thus the optimal path 120 does not need to be modified, nor any emergency operations executed to implement the fenceless cell protocol.

FIG. 1B and FIG. 1C show some implementations where the system 100 ensures operator 103 safety by scanning the service area with a dedicated sensor suite designed to identify the presence of a person or an event triggering body (e.g., the operator 103, another robot, animals, other objects) within the area of interest 116. The area of interest 116 may be a fixed location within the service area 105 that must remain free of event triggering bodies 103. In some implementations, the area of interest 116 defines an envelope around the path 120 taken by the robot 106 during the vehicle servicing operation. The thermal imaging device 102 may watch the envelope to determine if the event triggering body 103 enters the area of interest 116 and then generate an alert to pause or discontinue the vehicle service operation.

In some implementations, a fenceless cell protocol includes identifying a thermal state change within the service area 105 with the least one thermal imaging device 102. The thermal state change refers to an event that causes the temperature within the area of interest 116 to increase and/or fluctuate beyond a predefined threshold. The fenceless cell protocol may include determining if the thermal state change indicates the existence of an event triggering body 103 within the service area 105. For example, the thermal imaging device may utilize the computer vision and edge detection techniques discussed hereinbelow to exhibit characteristics indicative of the presence of the event triggering body 103. The fenceless cell protocol may then identify a position of the event triggering body 103 relative to the EOAT 108 and the vehicle 101 to determine if the optimal path 120 of the EOAT 108 needs to be modified to avoid contact or collisions with the event triggering body 103. The fenceless cell protocol may include generating an issue response protocol to avoid contact with the event triggering body 103 within the area of interest 116 In some implementations, the fenceless cell protocol includes severity assessments such that the system 100 can send an alert to emergency personnel that includes at least one of a time, a location, and a severity of the notable event. The issue response protocol may include or execute other damage mitigation operations. For example, the issue response protocol may include removing unwanted chemicals from within an area surrounding the event triggering body 103. In some implementations, 3D radar is used to supplement the thermal imaging device 102 when assessing the presence of the event triggering body 103 in the area of interest 116. In some implementations, one or more force sensors (e.g., an area monitoring sensor 110 mounted to a robot 106) are used to supplement the thermal imaging device 102 when assessing the presence of the event triggering body 103 in the area of interest 116. In some implementations, the 3D radar, the force sensor, and/or the thermal imaging device is a stand-alone module that can be used to provide fenceless cell capabilities to a variety of robotic systems.

In some implementations, the system 100 employs the aforementioned collection of sensing devices to generate a sparse representation of the vehicle 101 that contains at least one reference datum point that is correlated to the physical location of at least one serviceable portion 122 (e.g., relevant vehicle components, relevant patches of dirt, dents, scratches, holes, caked on debris, animal droppings, damaged components) of the vehicle 101. Further, the at least one serviceable area 122 may be at least one area 122 of the vehicle requiring cleaning. This correlation may generate a cleanliness rating or dirt score that is a unique characterization of the specific amount, content, and distribution of dirt that has accumulated on the vehicle 101.

Further, the system 100 may employ a machine learning model to rank, compare, and categorize the dirt in each of a plurality of serviceable portions 122 and generate a high-level representation of the vehicle 101 as a limited point cloud of serviceable portions 122. The dirt score may correspond to the density of the point cloud (e.g., higher densities are representative of dirtier vehicles that have a correspondingly high dirt score, lower densities are representative of cleaner vehicles that have a correspondingly low score).

In some implementations, the dirt score includes information about service areas 105 that require different servicing operations and/or EOAT 108 (e.g., spraying, brushing, buffing, painting). Further, the dirt score may be constructed using predefined criteria (e.g., key features for different type of vehicles, the desired service operation, external conditions). In some implementations, the system 100 is designed to restrict the amount of data gathered to only key features as identified in the dirt score. This restriction enables the system 100 to reduce processing overhead and improve the speed of pathing operations such that the system is able to perform dynamic path recognition operations. For example, the dirt score may include a representation of the dirt on the vehicle's 101 windshield as measured by the plurality of cameras (e.g. computer vision devices 104) positioned around a carwash. This dirt score may make no reference to the vehicle's 101 other characteristics beyond those relevant to avoiding collisions as well as achieving a desired level of cleanliness.

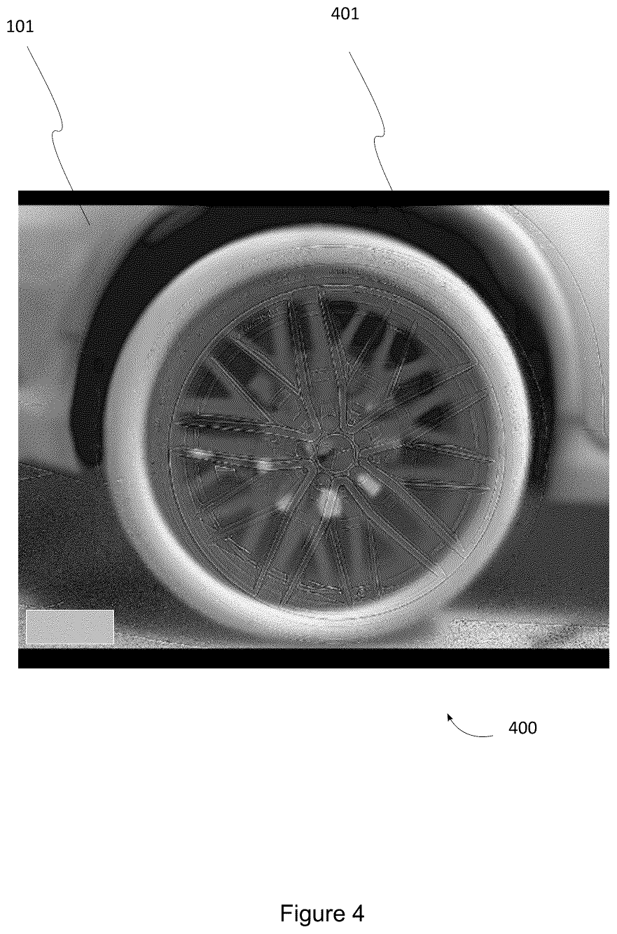

In some implementations, dynamic path recognition is an operation that determines the optimal and/or most efficient path for EOAT 108 to travel when performing a vehicle servicing operations on unique, and/or previously unencountered vehicles. In some implementations, the dynamic path recognition operation is able to generate sufficiently detailed paths for the EOAT 108 by identifying at least one physical characteristic of the vehicle (e.g., the position of a vehicle's brake pads—FIG. 4, the locations of dirt clusters from the dirt score) with the computer vision device 104 and then comparing that physical characteristic to at least one reference datum point (e.g., from area monitor sensor 110). Thus, the dynamic path recognition operation is able to generate sufficient features to begin the vehicle servicing operation, but the path 120 and the practical operation of the EOAT 108 may be improved through higher fidelity data for optimization. Additionally, the system 100 may employ a variety of robot motion and path planning routines (e.g., Probabilistic Roadmap Methods, Rapidly-exploring Random Trees (RRT), BiDirectional RRT, complete sampling planners, Probabilistic Complete Planners, Resolution Complete Planners, Occupancy grid maps, Dijsktra's algorithm, incremental search algorithms, Machine Learning path planning, spherical linear interpolation). In some implementations, the system 100 further reduces processing overhead and communication latency by implementing communication between the at least one thermal imaging device 102, the at least one computer vision device 104, the EOAT 108, and the at least one area monitor sensor 110 through a bidirectional stateless connection that is mediated by a multi-input multi-output (MIMO) sensor broker interface device 114. Thus, data is transferred between components with little-to-no computational overhead. Implementations may incorporate randomized parallel search algorithms into the path generation operations. Accordingly, the system 100 may employ parallel processing operations to reduce the time required to perform path recognition and planning operations.

In some implementations, the system 100 may employ a machine learning based dynamic path recognition model that utilizes input from the least one thermal imaging device 102, the at least one computer vision device 104, and at least one area monitor sensor 110 to dynamically track objects in the service area 105, to predict the path of the objects within the service area, to prevent collisions, and to generate dynamically updated optimal paths for the EOAT 108 based on the predicted paths. For example, the dynamic path recognition model may determine that a snowstorm has occurred by analyzing the content and distribution of dirt found on a given number of vehicles. The dynamic path recognition model may then modify the cleaning pattern or time spent on area for subsequent vehicles 101 and automatically direct the system to modify the content of the cleaning solution being used.

In some implementations, the system 100 uses convolutional neural networks (CNN) and/or Hough transforms for edge detection-based computer vision operations. For example, the system 100 may implement a thermal imaging-based image detection operation that includes receiving thermal images from at least one thermal imaging sensor included in the at least one computer vision device 104. In some implementations the thermal imaging sensor included in the at least one computer vision device 104 is separate and distinct from the thermal imaging device 102 and serves to augment the control loops governed by the at least one computer vision device 104 and the at least one area monitor sensor 110 rather than the fenceless cell protocol. The thermal imaging operation may include converting the thermal images to grayscale binary images and mapping an exterior surface of the vehicle 101 using the dynamic path recognition model to perform edge-detection-based computer vision analysis on the grayscale binary images. In some implementations the dynamic path recognition model employs machine vision techniques (e.g., multispectral imaging, hyperspectral imaging, infrared band imaging, line scan imaging, 3D imaging of surfaces, and X-ray imaging) to automatically identify the shape of the vehicle 101 and modify optimal path 120. Further implementations implement image processing techniques including, but not limited to, image stitching, registration, thresholding, pixel counting, segmentation, color analysis, blob detection and extraction, pattern recognition and template matching, and optical character recognition.

In some implementations, the model may be, or be part of a larger, artificial intelligence (AI) engine. The AI engine may be configured to use video camera, machine vision camera, depth sensor, and/or other outputs (e.g., from an image capturing device 104, an area monitor sensor 110, etc.) mounted either on the industrial robot, robotic arm, or cobot (e.g., robot 106 described above) or in proximity to the wash area robots 106 and automatically identify, segment, and position any anomaly on a vehicle that it has been trained to recognize (e.g., like bird droppings or other vehicle attributes such as headlights (left or right), windshield, mirrors, wiper blades, hood, doors, etc.) in the frames of view and within the operating range or envelope of robot 106.

The AI engine is configured to provide software running on the robot 106 controller with ability to automatically take control of the path of robot 106 and physically coordinate a safe path movement vector in real time and jog (x, y, z, yaw, pitch, and/or roll) the robot 106 right to an area of interest on the vehicle with the identified attribute(s). This AI powered teachable class detection, feedback and “burst” “conditional” automatic robot path alteration control enhances the capability of robots 106 for performing more diverse cleaning and/or other use case application examples with far less end user or application field engineering system programming work. The AI engine facilitates less implementation time and operator complexity on robot automation implementation. For example, with the AI engine, an operator is not required to create path programs scaled to specific sized robots, or combinations thereof. Instead, in some implementations, the AI engine comprises a classifier based on Bayes' Theorem (Bayesian belief based network architecture—i.e., not programmed with traditional “if” “then” “else” logic but rather using larger and larger training sets of data for more accuracy, and applying Bayes' Theorem using the probability of what is known to the AI engine (model), such that an outcome is determined with greater and greater accuracy each recursive time through a control loop, provided the sampling set increases through same period), and is trained to learn and process camera and/or other sensor data, to facilitate detections of vehicle attributes, determine future robotic movements, control robots 106, and/or perform other operations (e.g., position a robot 106 for cleaning a vehicle with specific and paint/finish coating irregularities recognized by the AI engine). The AI engine is configured to “learn” what a left vehicle headlight looks like, what an SUV looks like, what a pickup truck looks lie, a sedan, etc. Detecting and classifying attributes like these enhances the planning and controlling of robot 106 operations, as described herein.

For example, an output signal from an industrial grade wide format stereoscopic camera (an example of an area monitor sensor 110) may be provided as feedback data into the AI engine, which uses that data for robot 106 path planning and dynamic path change motions while any robot wash programs are executing. Such data may also be used for optimizing and maintaining the EOAT cleaning tool/application tool spray head at the application's specified distance from the surface of a vehicle. Note that these are just two possible representative examples. Other sensor data, combinations of sensor data, other applications, control of multiple robots 106, etc., are contemplated.

In some implementations, a plurality of robots 106 and EOAT 108 may be used simultaneously. In these implementations, the system coordinates the operation of all robots 106 to ensure the computer vision devices 104 and the area monitor sensors 110 are performing collision avoidance routines relative to, the vehicle 101, a person such as the operator 103, and the other robots.

### Example Flowchart(s)

The example flowchart(s) described herein convey example processing operations of methods that enable the various features and functionality of the system as described above. The processing operations of the methods presented below are intended to be illustrative and non-limiting. In some implementations, for example, the methods may be accomplished with one or more additional operations not described, and/or without one or more of the operations discussed. Additionally, the order in which the processing operations of the methods are illustrated (and described below) is not intended to be limiting.

In some implementations, the methods may be implemented in one or more processing devices (e.g., a digital processor, an analog processor, a digital circuit designed to process information, a field programmable gate array, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

For example, in some embodiments, software (e.g., instructions) may be stored electronically on an electronic storage medium in electronic storage associated with a processor 112 (FIG. 1), in a robot 106, and/or in other locations at the time of manufacture or set up of system 100. This software may be updated periodically, by electronic upload or download using a network such as the internet—e.g., download from a server associated with system 100, such that a software file from the server is a mirror image/physical copy of the most current up to date version of source code. In some embodiments, a unique random number may be generated and added to the download as metadata for tracking. This file download may comprise a protected file type and/or have other characteristics unreadable to humans.

FIG. 2 shows a flowchart for some implementations where the system 100 implements a plurality of nested control loops to control the functions of the robot 106 while executing the vehicle servicing operation. In some implementations, the nested control loops may be a hierarchical control system 200 where each loop operates at a different level of control, including a high-level strategic planning loop 202, a mid-level operational implementation loop 204, and a low-level actuator control loop 206. This control framework may be enabled by the system's 100 ability to identify and characterize a plurality of reference datum points from information captured by the least one thermal imaging device 102, the at least one computer vision device 104, and at least one area monitor sensor 110. Further, this framework allows for both broad oversight and fine-grained manipulation, enabling the robot 106 to adapt its cleaning strategy dynamically. For example, the system 100 may implement a first high-level loop 202 through a computer vision-based analysis of the dirt score that determines the overall level of cleanliness for the vehicle 101 that is to be washed. In some implementations, the system 100 includes a controller 124 that may include a plurality of processors 112 to employ an iterative analysis of servicing operations. This analysis enables the system 100 to generate a new dirt score based on multiple passes along the optimal path 120. Further implementations enable the system 100 to determine if any of the serviceable portions 122 of the vehicle 101 are sufficiently cleaned remove these portions 122 from the optimal path 120. The system 100 may determine if the at least one serviceable portion 122 requires additional cleaning operations when performing multiple iterations of the service operation and ignore these portions until subsequent iterations of the servicing operation.

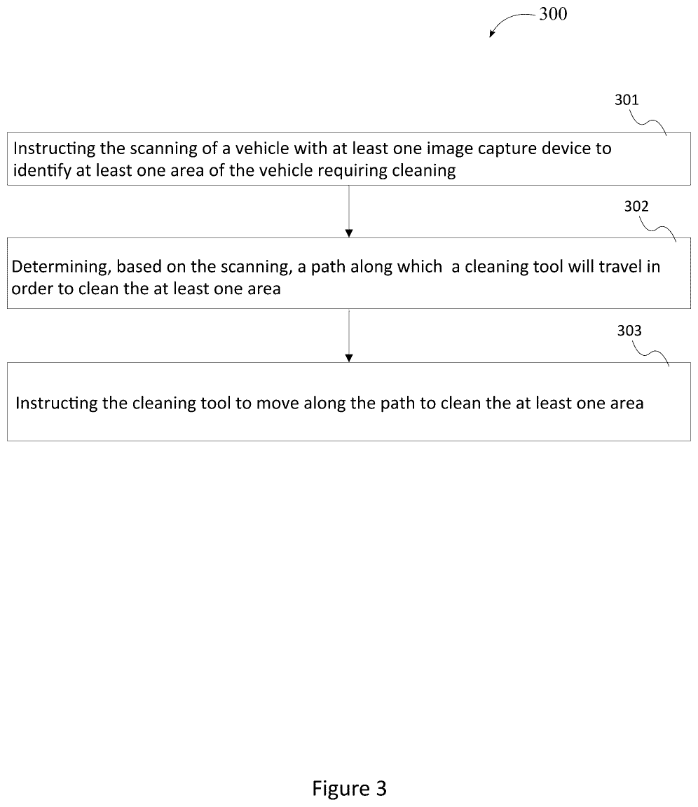

FIG. 3 illustrates a block diagram for a method 300 of implementing system 100. Method 300 may include scanning a service area 105 with at least one image capture device 102 to generate a dirt score that identifies at least one serviceable portion 122 of the vehicle 101 to be cleaned (Block 301). Method 300 may further include determining an optimal path 120 along which end of arm tooling (EOAT) 108 travels to perform a servicing operation on the at least one serviceable portion 122 of the vehicle 101 (Block 302). The method 300 may further include moving the EOAT 108 along the optimal path 120 in accordance with the dirt score and the servicing operation (Block 303). System may further include executing a damage mitigation operation if an unwanted overlap between an area of interest and a service area field of view whenever the individual is detected within the service area field of view, when a robot bumps into (e.g., as indicated by output from a force sensor) an operation or a vehicle, for example, or other similar events occur. The damage mitigation operation may include procedures such as alerting emergency personnel, terminating the servicing operation, notifying supervisors, evacuating the work cell of gasses, disconnecting power from equipment, stopping robot or other movement, using robots to assist fallen humans, and logging an accident report, for example.

FIG. 4 illustrates a preliminary representation 400 of the vehicle 101 generated in some implementations of the system 100 using the high-level control loop 202 to process only the data points that are relevant to the dirt score within a service area field of view 118. The service area field of view 118 may refer to the observable area for the constellation of sensing devices (e.g., 102, 104, 110) employed by the system 100. The preliminary representation 400 of the vehicle's 101 current state (e.g., position, orientation, cleanliness) may then be used to plan a general path 120 the robot 106/108 should take to clean the vehicle 101 efficiently, considering the vehicle's 101 size and shape. Further, the preliminary representation 400 may be updated as the vehicle servicing operation proceeds to provide accurate measurements of the dirt removal and/or progress of the vehicle servicing operation. The preliminary representation 400 may be used to generate instructions for where to move the robot 106 and how to manipulate the EOAT 108 during the vehicle servicing operation without also being used to generate a 3D model of the vehicle 101. Bypassing the modeling operation is intended to reduce the computational overhead required for real time dynamic path recognition.

In some implementations, generating the preliminary representation 400 of the vehicle 101 may be based on a disposition of at least one relevant physical characteristic 401 of the vehicle 101 as identified by the at least one computer vision device 104. Thus, the frame of reference, or coordinate space representation, for the preliminary representation 400 is bounded and/or characterized by the at least one physical characteristic 401 and the at least one reference datum point. The system 100 may then identify an appropriate preliminary cluster of data points that can be used as input for generating the optimal path 120. Generating the optimal path 120 for the EOAT 108 may include comparing the preliminary representation 400 to at least one reference datum point. For example, if the at least one relevant physical characteristic 401 includes a front wheel position and a rear wheel position for the vehicle 101, the preliminary representation 400 may include a calculation of the wheelbase of the vehicle. Said wheelbase may be equivalent to a distance between the front wheel position and the rear wheel position.

In some implementations, the system continuously builds upon and refines the data acquired during every step of the vehicle servicing operation. For example, a front and rear offset value (FROV) included in the preliminary representation 400 may be calculated equal the wheelbase divided by Pi. An overall vehicle length (OVL) included in the preliminary representation 400 may be equal to a sum of the wheelbase and twice the FROV. Accordingly, the system 100 is able to determine relevant information, including the location of the front and rear bumpers, wheelbase, and OVL and without requiring complex analysis. The wheelbase, the FROV, and the OVL may be input into the dynamic path recognition model for generating a first field of view characterized by the vehicle relative to the at least one computer vision device, a second field of view characterized by the vehicle relative to the EOAT, and a third field of view characterized by the vehicle relative to the at least one area monitor sensor. These three fields of view are representative of the datasets utilized by each of the three control loops. For example, the high-level loop may set the reference frames (e.g., service area size, vehicle dimensions, sensor location, operator position, areas of interest) for the robot's 106 movement, defining a global path 120 to follow.

Returning to FIG. 2, which shows an implementation where the system 100 may employ at least one mid-level loop 204 to refine the path 120 generated by the high-level loop. The mid-level loop may be tasked with planning and executing the specific routines and techniques employed to complete the servicing operation generated by the high-level loop 202. For example, when an interchangeable EOAT 108 is mounted onto a robotic arm (e.g. robot 106) and moved through the service area by the robotic arm 106 the mid-level loop 204 may rely on additional granular data to determine that an EOAT 108 with a first diameter spray nozzle should be used to clean a first section of the vehicle and a second diameter spray nozzle should be used to clean a second section of the vehicle. Alternatively, the mid-level loop 204 may determine that an EOAT 108 comprising a rotating spray nozzle connected to a feeder system, should be used to perform the cleaning operation as the robot 106 maneuvers the EOAT 108 along the optimal path 120 to wash a desired portion of an exterior surface of the vehicle. In further implementations, the mid-level loop 204 may determine that an EOAT 108 comprising a rotating brush mounted onto a boom arm should be used to perform the cleaning operation as the robot 106 maneuvers the EOAT 108 along the optimal path 120 to wash a desired portion of an exterior surface of the vehicle. In further implementations, the mid-level loop 204 may determine that an EOAT 108 comprising a blower device should be used to perform the cleaning operation as the robot 106 maneuvers the EOAT 108 along the optimal path 120 to dry a desired portion of the exterior surface of the vehicle 101. In some implementations, the mid-level loop 204 utilized data from the at least one area monitor sensors 110 as feedback sources to assess the vehicle servicing operation in real-time. For example, the mid-level loop 204 may determine that the EOAT 108 has exceeded a threshold cleaning time over a particular area and direct the high-level loop 202 to modify the optimal path 120 to avoid the area entirely. In some implementations, the EOAT is interchangeable to enable the execution of a series of different servicing operations such that the mid-level loop 204 is able to dynamically determine the EOAT 108 and operational characteristics (e.g., run time, power to apply, and the cleaning technique to use) for the vehicle servicing operation. In some implementations, the mid-level loop 204 may employ machine learning models to enable the robot 106 to perform executive decision-making tasks such as the detection of particularly dirty areas or the need to avoid sensitive components like antennas or mirrors. It adjusts the robot's trajectory in real-time to optimize cleaning effectiveness, creating localized reference frames for areas requiring special attention. In supplemental implementations, the system 100 may implement a plurality of mid-level loops 204 to simultaneously control disparate vehicle servicing operation, or to perform additional data acquisition and refinement operations to improve the accuracy and efficacy of the optimal path 120.

In some implementations, the high-level loop 202 generates the preliminary representation 400 and the optimal path 120 based on input from the at least one thermal imaging device 104. The high-level loop then passes these data 203 to the at least one mid-level loop where data 203 is integrated with additional data from the at least image capture device 102 which may be any form of computer vision devices 102 and the at least one area monitor sensor 110. Accordingly, implementations of the mid-level loop 204 may constantly access the most current data when performing vehicle service operations. The mid-level loop 204 performs dynamic planning and pathing to generate operation specific routines and refined optimal path data 205. The operation-specific routines 205 dictate how the EOAT 108 should function during any point of the vehicle servicing operation. Data 205 is passed from the mid-level loop 204 to both the low-level loop 206 and the high-level loop 202. This feedback facilitates training path recognition models and further refining the optimal path 120. In some implementations, the low-level loop mixes data 205 with data from the at least one computer vision device 104, the at least one area monitor sensor 110, the at least one thermal imaging device 102, and encoders, positional, sensors, timers, and other system relevant sensors 208. In some implementations, the low-level loop 206 generates machine instructions and component-level routines 207 that are passed to the robot to maneuver the robot 106 through physical space while performing complex tasks. Data may be passed from the low-level loop 206 to both the mid-level loop 204, and the high-level loop 202.

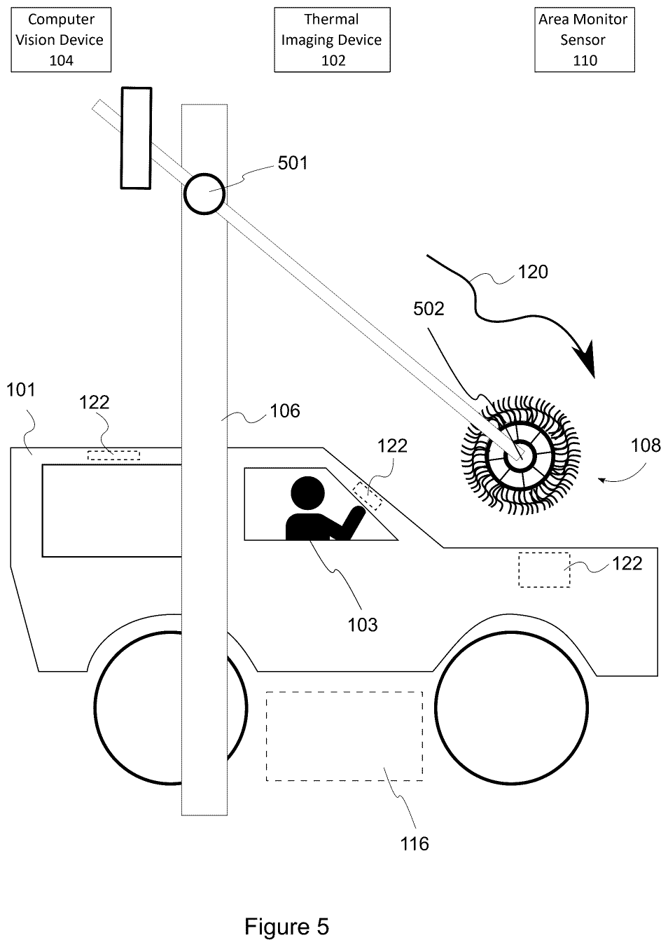

FIG. 5 shows an implementation where the system may employ at least one low-level loop 206 (FIG. 2) to control the robot's 106 actuators (motors, brushes, sprayers) 501 and EOAT 108 to execute the path 120 defined by the upper loops (e.g., 202, 204). The low-level loop 206 may continuously adjust the robot's 106 movements based on immediate and/or real-time feedback from at least one area monitor sensor 110 and or an application specific sensor 502 (e.g., tactile sensors, proximity sensors, force sensors, encoder assemblies, servomotor control modules) to ensure precise adherence to the path 120. Further, the at least one area monitor sensor 110 may be employed to aid in collision avoidance operations for the robot 106. In some implementations the at least one area monitor sensor 110 may monitor the state of components within the system 100 as well as the state of vehicles 101, operators 103, and objects within the service area 105. The at least one low-level loop 206 may use this granular sensor data to modify the moment-by-moment actuator output in response to environmental and/or predefined conditions. In some implementations, the low-level loop 206 is tasked with issuing the commands to actuators that drive the robot 106 as the EOAT 108 traverses through physical space.

An example low-level loop 206 may include receiving signals from a plurality of encoders 502 indicating a position of the robot 106 and sending instructions to at least one motor 501 associated with the robotic arm 106 to generate movement between the EOAT 108 and the vehicle 101 such that the EOAT 108 is oriented to perform the servicing operation without collision between the robotic arm, the EOAT, an event triggering body 103, and the vehicle 101. Further, the at least one area monitor sensor 110 may include a proximity sensor designed to ensure a current distance between the EOAT 108 and the vehicle 101 is greater than a minimum clearance distance to avoid damaging the vehicle's 101 exterior. In some implementations, the minimum clearance distance is 6 inches. As another example, the at least one area monitor sensor 110 may include a force sensor mounted in or to the EOAT, This sensor may be configured to output a force signal such that force from a collision between the EOAT and a vehicle or operator that breaches a threshold causes the system to stop all activity.

In some implementations, the various components or modules illustrated in the Figures or described in the foregoing paragraphs may include one or more computing devices that are programmed to perform the functions described herein. The computing devices may include one or more electronic storages, one or more physical processors programmed with one or more computer program instructions, and/or other components. The computing devices may include communication lines or ports to enable the exchange of information within a network or other computing platforms via wired or wireless techniques (e.g., Ethernet, fiber optics, coaxial cable, Wi-Fi, Bluetooth, near field communication, or other technologies). The computing devices may include a plurality of hardware, software, and/or firmware components operating together. For example, the computing devices may be implemented by a cloud of computing platforms operating together as the computing devices. Cloud components may include control circuitry configured to perform the various operations needed to implement the disclosed implementations. Cloud components may include cloud-based storage circuitry configured to electronically store information. Cloud components may also include cloud-based input/output circuitry configured to display information.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein. The processors may be programmed to execute computer program instructions by software; hardware; firmware; some combination of software, hardware, or firmware; and/or other mechanisms for configuring processing capabilities on the processors.

It should be appreciated that the description of the functionality provided by the components or modules described herein is for illustrative purposes, and is not intended to be limiting, as any of the components or modules may provide more or less functionality than is described. For example, one or more of the components or modules may be eliminated, and some or all of its functionality may be provided by other ones of the components or modules. As another example, additional components or modules may be programmed to perform some or all of the functionality attributed herein to one of the components or modules.

The following list of implementations describes various aspects of the systems and methods described herein, which may be combined in any combination.

Example Implementation 1: A computer-readable medium storing instructions which when executed by a processor cause performance of a method for dynamically guided vehicle servicing, which may include: instructing the scanning of a vehicle with at least one image capture device to identify at least one area of a vehicle requiring cleaning; determining, based on the scanning, a path along which a cleaning tool will travel in order to clean the at least one area; and instructing the cleaning tool to move along the path to clean the at least one area.
Example Implementation 2: The computer-readable medium of Example Implementation 1, the method further may include: scanning a service area with at least one thermal imaging device to determine if a person is within an area of interest; and executing a mitigation operation if the person is in an unwanted position within the area of interest.
Example Implementation 3: The computer-readable medium of Example Implementation 1 or Example Implementation 2, where the method further may include: identifying a thermal state change within the service area with the least one thermal imaging device; and determining if the thermal state change indicates the existence of the person within the area of interest.
Example Implementation 4: The computer-readable medium of any one of Example Implementations 1-3, where the method further may include: identifying a position of the person relative to the EOAT and the vehicle; and generating issue response protocol to avoid contact with the person within the area of interest.
Example Implementation 5: The computer-readable medium of any one of Example Implementations I-4, where the issue response protocol includes modifying the optimal path to avoid collision with the person.
Example Implementation 6: The computer-readable medium of any one of Example Implementations 1-5, where the issue response protocol includes removing unwanted chemicals from within an area surrounding the person.
Example Implementation 7: The computer-readable medium of any one of Example Implementations I-6, where the issue response protocol includes generating a notification for emergency personnel that includes at least one of a time, a location, and a severity of an issue.
Example Implementation 8: The computer-readable medium of any one of Example Implementations 1-7, where the at least one thermal imaging device includes longwave-infrared (LWIR) focal-plane arrays to enable passively cooled thermal-imaging operations.
Example Implementation 9: The computer-readable medium of any one of Example Implementations 1-8, where the at least one thermal imaging device is a plurality of thermal imaging devices distributed about the service area, and where the plurality of thermal imaging devices is optically coupled to the service area.
Example Implementation 10: The computer-readable medium of any one of Example Implementations 1-9, where at least one reference datum point includes a plurality of reference datum points correlated to physical characteristics of the service area.
Example Implementation 11: The computer-readable medium of any one of Example Implementations 1-10, where the at least one reference datum point includes information captured by at least one thermal imaging device, the at least one image capture device, and at least one area monitor sensor.
Example Implementation 12: The computer-readable medium of any one of Example Implementations 1-11, where at least one thermal imaging device, the at least one image capture device, at least one area monitor sensor, and the EOAT communicate through a bidirectional stateless connection that is mediated by a multi-input multi-output (MIMO) sensor broker interface device.
Example Implementation 13: The computer-readable medium of any one of Example Implementations 1-12, where the EOAT is interchangeable to enable the execution of a series of different servicing operations.
Example Implementation 14: The computer-readable medium of any one of Example Implementations 1-13, where the method further may include: scanning the service area with the at least one image capture device to determine a current position of the vehicle; and performing a dynamic path recognition operation to update the optimal path based on the current position of the vehicle.
Example Implementation 15: The computer-readable medium of any one of Example Implementations 1-14, where the method further may include a machine learning based dynamic path recognition model that utilizes input from the least one thermal imaging device, the at least one image capture device, and at least one area monitor sensor.
Example Implementation 16: The computer-readable medium of any one of Example Implementations 1-15, where the machine learning model dynamically tracks objects in the service area, to predict the path of the objects within the service area, to prevent collisions, and to generate dynamically updated optimal paths for the EOAT based on the predicted paths.
Example Implementation 17: The computer-readable medium of any one of Example Implementations 1-16, where the method further may include generating a preliminary representation of the vehicle based on a disposition of at least one relevant physical characteristic of the vehicle as identified by the at least one image capture device.
Example Implementation 18: The computer-readable medium of any one of Example Implementations 1-17, where the method further may include generating an optimal path by comparing the preliminary representation to at least one reference datum point.
Example Implementation 19: The computer-readable medium of any one of Example Implementations 1-18, where the at least one relevant physical characteristic includes a front wheel position and a rear wheel position for the vehicle, and where the preliminary representation includes a wheelbase of the vehicle, and where the wheelbase equals a distance between the front wheel position and the rear wheel position.
Example Implementation 20: The computer-readable medium of any one of Example Implementations 1-19, where a front and rear offset value (FROV) included in the preliminary representation is equal to the wheelbase divided by Pi, and where an overall vehicle length (OVL) included in the preliminary representation equals a sum of the wheelbase and twice the FROV.
Example Implementation 21: The computer-readable medium of any one of Example Implementations 1-20, where the wheelbase, the FROV, and the OVL are input into the dynamic path recognition model for generating a first field of view characterized by the vehicle relative to the at least one computer vision device, a second field of view characterized by the vehicle relative to the EOAT, and a third field of view characterized by the vehicle relative to the at least one area monitor sensor.
Example Implementation 22: The computer-readable medium of any one of Example Implementations 1-21, where the method further may include: receiving thermal images from at least one thermal imaging sensor included in the at least one computer vision device; converting the thermal images to grayscale binary images; and mapping an exterior surface of the vehicle.
Example Implementation 23: The computer-readable medium of any one of Example Implementations 1-22, where mapping the exterior surface uses the dynamic path recognition model to perform edge-detection-based computer vision analysis on the grayscale binary images.
Example Implementation 24: The computer-readable medium of any one of Example Implementations 1-23, where the EOAT includes a rotating spray nozzle connected to a feeder system, and where the optimal path maneuvers the EOAT around the vehicle to wash a desired portion of an exterior surface of the vehicle.
Example Implementation 25: The computer-readable medium of any one of Example Implementations 1-24, where the EOAT includes a rotating brush mounted onto a boom arm, and where the optimal path maneuvers the EOAT around the vehicle to brush a desired portion of an exterior surface of the vehicle, and where an encoder monitors the position of the boom arm.
Example Implementation 26: The computer-readable medium of any one of Example Implementations 1-25, where the EOAT includes a blower device, and where the optimal path maneuvers the EOAT around the vehicle to dry a desired portion of an exterior surface of the vehicle.
Example Implementation 27: The computer-readable medium of any one of Example Implementations 1-26, where the EOAT is mounted onto a robotic arm and moved through the service area by the robotic arm.
Example Implementation 28: The computer-readable medium of any one of Example Implementations 1-27, where the method further may include: receiving signals from a plurality of encoders indicating a position of the robotic arm; and sending instructions to at least one motor associated with the robotic arm to generate relative movement between the EOAT and the vehicle such that the EOAT is oriented to perform the servicing operation without collision between the robotic arm, the EOAT, a person, and the vehicle.
Example Implementation 29: The computer-readable medium of any one of Example Implementations 1-28, where the robotic arm maneuvers the EOAT to ensure a current distance between the EOAT and the vehicle is greater than a minimum clearance distance.
Example Implementation 30: The computer-readable medium of any one of Example Implementations 1-29, where the method further may include: identifying at least one serviceable portion of the vehicle based on the vehicle image data; and generating a cleanliness rating based on the at least one serviceable portion and the vehicle image data.
Example Implementation 31: A system for dynamically guided vehicle servicing may include: one or more processors configured to: scan a vehicle with at least one image capture device to identify at least one area of a vehicle requiring cleaning; determine, based on the scanning, a path along which a cleaning tool will travel in order to clean the at least one area; and instruct the cleaning tool to move along the path to clean the at least one area.
Example Implementation 32: The system of Example Implementation 31, where the one or more processors are further configured to: scan a service area with at least one thermal imaging device to determine if a person is within an area of interest; and execute a mitigation operation if the person is in an unwanted position within the area of interest.
Example Implementation 33: The system of Example Implementation 31 or Example Implementation 32, where the one or more processors are further configured to: identify a thermal state change within the service area with the least one thermal imaging device; and determine if the thermal state change indicates the existence of the person within the area of interest.
Example Implementation 34: The system of any one of Example Implementations 31-33, where the one or more processors are further configured to: identify a position of the person relative to the EOAT and the vehicle; and generate issue response protocol to avoid contact with the person within the area of interest.
Example Implementation 35: The system of any one of Example Implementations 31-34, where the one or more processors are further configured to modify the optimal path to avoid collision with the person.
Example Implementation 36: The system of any one of Example Implementations 31-35, where the one or more processors are further configured to remove unwanted chemicals from within an area surrounding the person.
Example Implementation 37: The system of any one of Example Implementations 31-36, where the one or more processors are further configured to generate a notification for emergency personnel that includes at least one of a time, a location, and a severity of an issue.
Example Implementation 38: The system of any one of Example Implementations 31-37, where the at least one thermal image device includes longwave-infrared (LWIR) focal-plane arrays to enable passively cooled thermal-imaging operations.
Example Implementation 39: The system of any one of Example Implementations 31-38, where the at least one thermal image device is a plurality of thermal imaging devices distributed about the service area, and where the plurality of thermal imaging devices is optically coupled to the service area.
Example Implementation 40: The system of any one of Example Implementations 31-39, where at least one reference datum point includes a plurality of reference datum points correlated to physical characteristics of the service area.
Example Implementation 41: The system of any one of Example Implementations 31-40, where the at least one reference datum point includes information captured by at least one thermal image device, the at least one image capture device, and at least one area monitor sensor.
Example Implementation 42: The system of any one of Example Implementations 31-41, where at least one thermal image device, the at least one image capture device, at least one area monitor sensor, and the EOAT communicate through a bidirectional stateless connection that is mediated by a multi-input multi-output (MIMO) sensor broker interface device.
Example Implementation 43: The system of any one of Example Implementations 31-42, where the EOAT is interchangeable to enable the execution of a series of different service operations.
Example Implementation 44: The system of any one of Example Implementations 31-43, where the one or more processors are further configured to: scan the service area with the at least one image capture device to determine a current position of the vehicle; and perform a dynamic path recognition operation to update the optimal path based on the current position of the vehicle.
Example Implementation 45: The system of any one of Example Implementations 31-44, where the one or more processors are further configured to: utilize a machine learn based dynamic path recognition model that utilizes input from the least one thermal imaging device, the at least one image capture device, and at least one area monitor sensor.
Example Implementation 46: The system of any one of Example Implementations 31-45, where the machine learning model dynamically tracks objects in the service area, to predict the path of the objects within the service area, to prevent collisions, and to generate dynamically updated optimal paths for the EOAT based on the predicted paths.
Example Implementation 47: The system of any one of Example Implementations 31-46, where the one or more processors are further configured to: generate a preliminary representation of the vehicle based on a disposition of at least one relevant physical characteristic of the vehicle as identified by the at least one image capture device.
Example Implementation 48: The system of any one of Example Implementations 31-47, where the one or more processors are further configured to: generate an optimal path by comparing the preliminary representation to at least one reference datum point.
Example Implementation 49: The system of any one of Example Implementations 31-48, where the at least one relevant physical characteristic includes a front wheel position and a rear wheel position for the vehicle, and where the preliminary representation includes a wheelbase of the vehicle, and where the wheelbase equals a distance between the front wheel position and the rear wheel position.
Example Implementation 50: The system of any one of Example Implementations 31-49, where a front and rear offset value (FROV) included in the preliminary representation is equal to the wheelbase divided by Pi, and where an overall vehicle length (OVL) included in the preliminary representation equals a sum of the wheelbase and twice the FROV.
Example Implementation 51: The system of any one of Example Implementations 31-50, where the one or more processors are further configured to: input the wheelbase, the FROV, and the OVL into the dynamic path recognition model for generating a first field of view characterized by the vehicle relative to the at least one computer vision device, a second field of view characterized by the vehicle relative to the EOAT, and a third field of view characterized by the vehicle relative to the at least one area monitor sensor.
Example Implementation 52: The system of any one of Example Implementations 31-51, where the one or more processors are further configured to: receive thermal images from at least one thermal imaging sensor included in the at least one computer vision device; convert the thermal images to grayscale binary images; and map an exterior surface of the vehicle.
Example Implementation 53: The system of any one of Example Implementations 31-52, where the one or more processors are further configured to: map the exterior surface using the dynamic path recognition model to perform edge-detection-based computer vision analysis on the grayscale binary images.
Example Implementation 54: The system of any one of Example Implementations 31-53, where the EOAT includes a rotating spray nozzle connected to a feeder system, and where the optimal path maneuvers the EOAT around the vehicle to wash a desired portion of an exterior surface of the vehicle.
Example Implementation 55: The system of any one of Example Implementations 31-54, where the EOAT includes a rotating brush mounted onto a boom arm, and where the optimal path maneuvers the EOAT around the vehicle to brush a desired portion of an exterior surface of the vehicle, and where an encoder monitors the position of the boom arm.
Example Implementation 56: The system of any one of Example Implementations 31-55, where the EOAT includes a blower device, and where the optimal path maneuvers the EOAT around the vehicle to dry a desired portion of an exterior surface of the vehicle.
Example Implementation 57: The system of any one of Example Implementations 31-56, where the EOAT is mounted onto a robotic arm and moved through the service area by the robotic arm.
Example Implementation 58: The system of any one of Example Implementations 31-57, where the one or more processors are further configured to: receive signals from a plurality of encoders indicating a position of the robotic arm; and send instructions to at least one motor associated with the robotic arm to generate relative movement between the EOAT and the vehicle such that the EOAT is oriented to perform the servicing operation without collision between the robotic arm, the EOAT, a person, and the vehicle.
Example Implementation 59: The system of any one of Example Implementations 31-58, where the robotic arm maneuvers the EOAT to ensure a current distance between the EOAT and the vehicle is greater than a minimum clearance distance.
Example Implementation 60: The system of any one of Example Implementations 31-59, where the one or more processors are further configured to: identify at least one serviceable portion of the vehicle based on the vehicle image data; and generate a cleanliness rating based on the at least one serviceable portion and the vehicle image data.

Although the present systems and methods have been described in detail for the purpose of illustration based on what is currently considered to be the most practical and preferred implementations, it is to be understood that such detail is solely for that purpose and that the systems and methods are not limited to the disclosed implementations, but, on the contrary, is intended to cover modifications and equivalent arrangements that are within the scope of the appended claims. For example, it is to be understood that the present systems and methods contemplate that, to the extent possible, one or more features of any implementation can be combined with one or more features of any other implementation.

What is claimed is:

1. A computer-readable medium storing instructions which, when executed by a processor, cause performance of a method for dynamically guided vehicle servicing, comprising:
instructing scanning of a vehicle with at least one image capture device to identify at least one area of the vehicle requiring cleaning;
determining, based on the scanning, a path along which a cleaning tool will travel in order to clean the at least one area; and
instructing the cleaning tool to move along the path to clean the at least one area.

2. The computer-readable medium according to claim 1, wherein:
the method further comprises scanning of a service area with at least one thermal imaging device to determine if a person is within an area of interest; and
executing a mitigation operation if the person is within the area of interest.

3. The computer-readable medium according to claim 2, wherein the scanning of the service area includes:
identifying a thermal state change within the service area with the least one thermal imaging device; and
determining if the thermal state change indicates existence of the person within the area of interest.

4. The computer-readable medium according to claim 2, the method further comprising: identifying a position of the person relative to the cleaning tool and the vehicle; and generating at least one issue response protocol in response thereto.

5. The computer-readable medium according to claim 4, wherein the issue response protocol includes modifying the path.

6. The computer-readable medium according to claim 4, wherein the issue response protocol includes removing unwanted chemicals from within an area surrounding the person.

7. The computer-readable medium according to claim 4, wherein the issue response protocol includes generating a notification for emergency personnel that includes at least one of a time, a location, and a severity of an issue.

8. The computer-readable medium according to claim 2, wherein the at least one thermal imaging device includes longwave-infrared (LWIR) focal-plane arrays to enable passively cooled thermal-imaging operations.

9. The computer-readable medium according to claim 8, wherein the at least one thermal imaging device is a plurality of thermal imaging devices distributed about the service area, and wherein the plurality of thermal imaging devices is optically coupled to the service area.

10. The computer-readable medium according to claim 1, wherein at least one reference datum point includes a plurality of reference datum points correlated to physical characteristics of the service area, and wherein a dirt score is generated based on data generated by the at least one image capture device.

11. The computer-readable medium according to claim 10, wherein the at least one reference datum point includes information captured by at least one thermal imaging device, the at least one image capture device, and at least one area monitor sensor.

12. The computer-readable medium according to claim 1, wherein at least one thermal imaging device, the at least one image capture device, at least one area monitor sensor, and the cleaning tool communicate through a bidirectional stateless connection that is mediated by a multi-input multi-output (MIMO) sensor broker interface device.

13. The computer-readable medium according to claim 1, wherein the cleaning tool is interchangeable to enable the execution of a series of different servicing operations.

14. The computer-readable medium according to claim 1, the method further comprising:
scanning the service area with the at least one image capture device to determine a current position of the vehicle; and
performing a dynamic path recognition operation to update the path based on the current position of the vehicle.

15. The computer-readable medium according to claim 14, the method further comprising utilizing a machine learning based dynamic path recognition model that utilizes input from at least one thermal imaging device, the at least one image capture device, and at least one area monitor sensor.

16. The computer-readable medium according to claim 15, wherein the machine learning model dynamically tracks objects in the service area, to predict the path of the objects within the service area, to prevent collisions, and to generate dynamically updated paths for the cleaning tool based on the predicted paths.

17. The computer-readable medium according to claim 1, the method further comprising generating a preliminary representation of the vehicle based on a disposition of at least one relevant physical characteristic of the vehicle as identified by the at least one image capture device.

18. The computer-readable medium according to claim 17, the method further comprising generating an optimal path by comparing the preliminary representation to at least one reference datum point.

19. The computer-readable medium according to claim 17, wherein the at least one relevant physical characteristic includes a front wheel position and a rear wheel position for the vehicle, and wherein the preliminary representation includes a wheelbase of the vehicle, and wherein the wheelbase equals a distance between the front wheel position and the rear wheel position.

20. The computer-readable medium according to claim 19, wherein a front and rear offset value (FROV) included in the preliminary representation is equal to the wheelbase divided by Pi, and wherein an overall vehicle length (OVL) included in the preliminary representation equals a sum of the wheelbase and twice the FROV.
